(19) United States
(12) Patent Application Publication
(10) Pub. No.: US 2010/0083163 A1
(43) Pub. Date: Apr. 1, 2010

(54) Methods and Systems for Optimizing Webpage Content Based on a Screen Orientation of a Device

(75) Inventors: Farzin Maghoul, Hayward, CA (US); Paul Yiu, Mountain View, CA (US); Marc Davis, San Francisco, CA (US); Athellina Athsani, San Jose, CA (US); Jeonghee Yi, San Jose, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 12/240,323

(22) Filed: Sep. 29, 2008

(51) Int. Cl. G06F 3/048

(52) U.S. Cl. 715/781

(57) ABSTRACT

Systems and methods for optimizing webpage content based on a screen orientation of a device are disclosed. Generally, a plurality of content chunks comprising a webpage to be displayed on a device is identified. An indication of a screen orientation of the device is received and webpage content to be displayed on the device is modified based at least in part on the screen orientation of the device, the identified plurality of content chunks, and a focus priority associated with each content chunk of the plurality of content chunks.

### BACKGROUND

Devices, such as cellular phones and desktop displays, have begun providing the ability to detect an orientation of a screen of the device and to provide different functionality based on the screen orientation of the device. Online advertisement service providers, such as Yahoo! Search Marketing®, and website providers desire to capitalize on this functionality of devices to present advertisements and webpage content to Internet users in new ways. Existing screen alteration technologies do not personalize the ordering of content for display in that orientation nor re-arrange content between display orientations.

### BRIEF DESCRIPTION OF THE DRAWINGS

FIG. 1 is a block diagram of an environment in which systems for optimizing webpage content based on a screen orientation of a device may operate;

FIG. 2 is a block diagram of a system for optimizing webpage content based on a screen orientation of a device;

FIG. 3a illustrates a mobile device with a screen of the mobile device orientated in a vertical orientation (also known as a portrait orientation);

FIG. 3b illustrates a mobile device with a screen of the mobile device orientated in a horizontal orientation (also known as a landscape orientation);

FIG. 4 is a flow chart of a method for optimizing webpage content based on a screen orientation of a device;

FIG. 5 is a diagram illustrating content chunks of a webpage;

FIG. 6 is a diagram illustrating a grid layout of a webpage; and

FIG. 7 is a flow chart of another method for optimizing webpage content based on a screen orientation of a device.

### DETAILED DESCRIPTION OF THE DRAWINGS

The present disclosure is directed to methods and systems for optimizing webpage content based on a screen orientation of a device. Generally, the methods and systems described below provide the ability to alter the presentation of webpage content, including digital ads, on a device based on a screen orientation of the device.

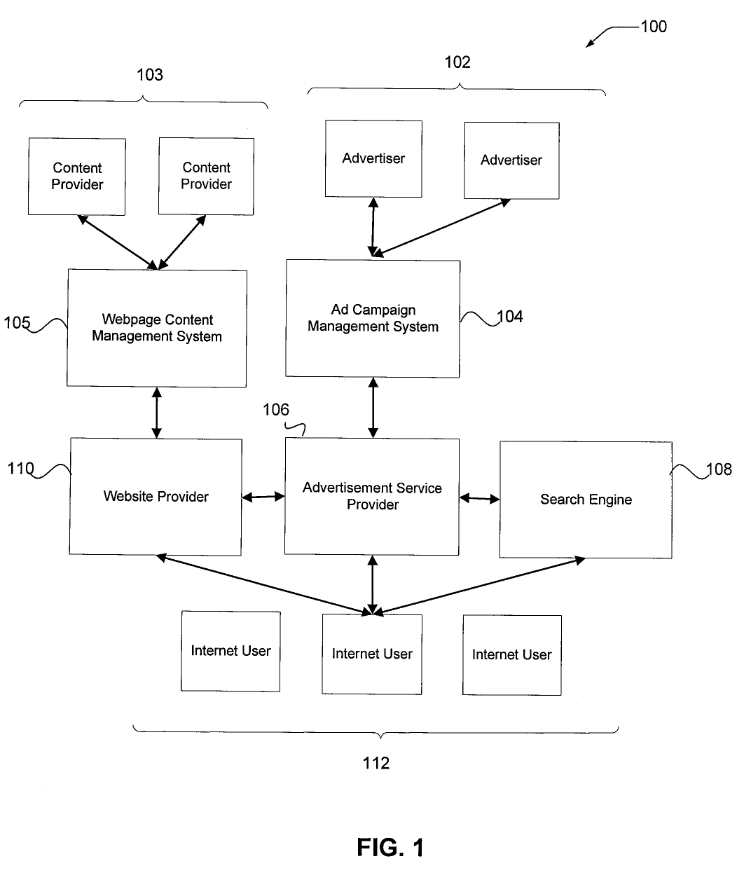

FIG. 1 is a block diagram of an environment 100 in which systems for optimizing webpage content based on a screen orientation of a device may operate. The environment 100 may include a plurality of advertisers 102, a plurality of content providers 103, an ad campaign management system 104, a webpage content management system 105, an ad provider 106, a search engine 108, a website provider 110, and a plurality of Internet users 112.

Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The digital ad may be a graphical ad that appears on a website viewed by an Internet user 112, a sponsored search listing that is served to an Internet user 112 in response to a search performed at a search engine, a video ad, a graphical banner ad based on a sponsored search listing, and/or any other type of online marketing media known in the art.

Additionally, a content provider 103 interacts with a webpage content management system 105 to create webpages that the website provider 110 serves to Internet users, as explained in more detail below.

When an Internet user 112 performs a search at a search engine 108, the search engine 108 typically receives a search query comprising one or more keywords. In response to the search query, the search engine 108 returns search results to the Internet user 112 that include one or more search listings that may include hyperlinks to webpages created using the content management system 105. The search engine 108 identifies the search listings based on keywords within the search query provided by the Internet user 112.

The ad provider 106 may also receive a digital ad request based on the search query submitted to the search engine 108. In response to the digital ad request, the ad provider 106 serves one or more digital ads created using the ad campaign management system 104 to the search engine 108 and/or the Internet user 112 based on keywords within the search query provided by the Internet user 112.

Similarly, when an Internet user 112 requests a webpage served by the website provider 110, the website provider 110 serves webpage content to the Internet user 112 created using the webpage content management system 105. The ad provider 106 may additionally receive a digital ad request when the Internet user 112 requests a webpage served by the website provider 110. The digital ad request may include data such as keywords obtained from the content of the webpage. In response to the digital ad request, the ad provider 106 serves one or more digital ads created using the ad campaign management system 104 to the website provider 110 and/or the Internet user 112 based on the keywords within the digital ad request.

When the webpage content and digital ads are served, the ad campaign management system 104, the webpage content management system 105, the ad provider 106, and/or the website provider 110 may record and process information associated with the served webpage content and digital ads. For example, with respect to digital ads, the ad campaign management system 104 and/or the ad provider 106 may process information associated with served digital ads including detailed user mouse movements, clicks, and/or other interaction events for purposes such as billing, reporting, or ad campaign optimization. The ad campaign management system 104 and/or the ad provider 106 may record and process information such as the factors that caused the ad provider 106 to select the served digital ads; whether the Internet user 112 clicked on a URL or other link associated with one of the served digital ads; what additional search listings or digital ads were served with each served digital ad; a position on a webpage of a digital ad when the Internet user 112 clicked on a digital ad; and/or whether the Internet user 112 clicked on a different digital ad when a digital ad was served. One example of an ad campaign management system that may perform these types of actions is disclosed in U.S. patent application Ser. No. 11/413,514, filed Apr. 28, 2006, and assigned to Yahoo! Inc., the entirety of which is hereby incorporated by reference.

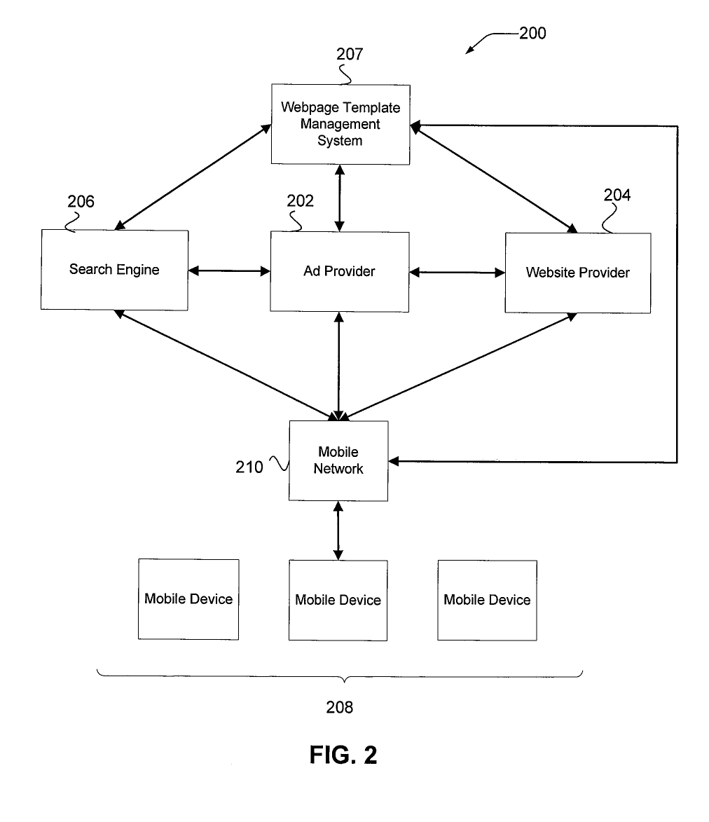

FIG. 2 is a block diagram of a system for optimizing webpage content based on a screen orientation of a device. Generally, the system 200 includes an ad provider 202, a website provider 204, a search engine 206, a webpage template management system 207, and a plurality of mobile devices 208 communicating with the ad provider 202, website provider 204, search engine 206 and/or webpage template management system 207 over a mobile network 210. The ad provider 202, website provider 204, Internet search engine 206, and webpage template management system 207 may additionally communicate with each other over one or more external or internal networks. In some implementations, the webpage template management system 207 may be part of the ad provider 202, website provider 204, or search engine 206, where in other implementations, the webpage template management system 207 is distinct from the ad provider 202, website provider 204, and search engine 206.

The mobile network 210 over which the mobile devices 208 communicate with the ad provider 202, website provider 204, search engine 206 and/or webpage template management system 207, and the one or more external or internal networks over which the ad provider 202, website provider 204, search engine 206, and webpage template management system 207 communicate with each other, may include local area networks (LAN), wide area networks (WAN), and/or the Internet, and may be implemented with wireless or wired communication mediums such as wireless fidelity (WiFi), Bluetooth, landlines, satellites, and/or cellular communications. Further, the ad provider 202, website provider 204, search engine 206, and webpage template management system 207 may be implemented as software code running in a processor of a single server, plurality of servers, or any other type of computing device known in the art. Additionally the mobile devices 208 may be implemented as software code running on a processor of a mobile device that includes hardware such as accelerometers that are able to detect an orientation of a screen of the mobile device 208, also known as a screen orientation of the mobile device 208. Examples of such mobile devices 208 are the iPhone® and ipod Touch® manufactured by Apple Inc..

Generally, an Internet user interacts with a mobile device 208 and performs an action such as requesting a webpage from the website provider 204 or submitting a search query to the Internet search engine 204. In response, the webpage template management system 207 collects webpage content to be sent to the mobile device 208 from the ad provider 202, website provider 204 and/or the Internet search engine 206. In some implementations, the webpage template management system 207 identifies content chunks within the webpage content and designates a focus priority to each of the content chunks, as explained in more detail below. However, in other implementations, a content provider provides mobile-device specific webpages in system templatized content chunks and designates focus priorities to these content chunks.

The mobile device 208 detects an orientation of a screen of the mobile device 208 and sends information to the webpage template management system 207 that identifies the screen orientation of the mobile device 208. In response, the webpage template management system 207 may modify the webpage content to be displayed on the mobile device 208 by performing actions such as shuffling the placement of the identified content chunks in the webpage content, or choosing digital ads to render on a webpage, based at least in part on the screen orientation of the mobile device 208 and the focus priorities associated with the content chunks. The webpage template management system 207 then sends the rearranged webpage content to the mobile device 208.

In other implementations, in response to the Internet user performing actions such as requesting a webpage from the website provider 204 or submitting a search query to the Internet search engine 204, webpage content is sent from the ad provider 202, website provider 204, the Internet search engine 206, and/or the webpage template management system 207 to the mobile device 208 for display on the mobile device 208. As explained in more detail below, the webpage content sent to the mobile device 208 is structured in a webpage template. The webpage template positions content chunks on a webpage based on a screen orientation of the mobile device 208. The webpage template additionally renders digital ads on a webpage based on a screen orientation of the mobile device.

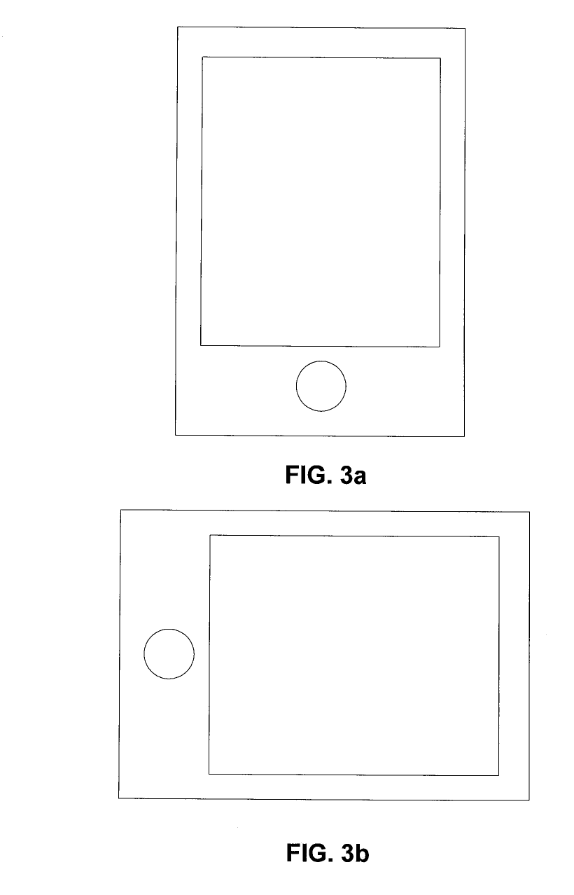

The webpage template may dynamically modify received webpage content to alter the positioning of the content chunks comprising the webpage content based on a detected screen orientation of the mobile device 208. For example, the webpage template may position digital ads at a prominent position at the top of a webpage when the mobile device 208 is orientated in a vertical orientation (also known as a portrait orientation) as shown in FIG. 3a, and the webpage template may position digital ads at a prominent position on a side of a webpage when the mobile device 208 is orientated in a horizontal orientation (also known as a landscape orientation) as shown in FIG. 3b. It should be appreciated that other screen orientations could be used such as positioning the screen at a 45 degree angle.

The webpage template may additionally render a different version of a digital ad based on a screen orientation of a mobile device. For example, the webpage template may render a graphical version of a digital ad when the mobile device 208 is orientated in a vertical orientation and the webpage template may render a textual version of a digital ad when the mobile device 208 is orientated in a horizontal orientation.

The webpage template may additionally render different digital ads all together based on a screen orientation of a mobile device. For example, the webpage template may render a first digital ad determined by the ad provider 204 using a first search algorithm when the mobile device 208 is orientated in a vertical orientation and the webpage template may render a second different digital ad determined by the ad provider 204 using a second search algorithm when the mobile device 208 is orientated in a horizontal orientation.

It will be appreciated that in some implementations, the webpage template may combine two or more of the above-described features to render digital ads in different ways based on a screen orientation of a mobile device 208. For example, the webpage template may render a textual version of a digital ad at a prominent position at a top of a webpage when the mobile device 208 is orientated in a vertical orientation, and the webpage template may render a graphical version of the digital ad at a prominent position at a side of a webpage when the mobile device 208 is orientated in a horizontal orientation.

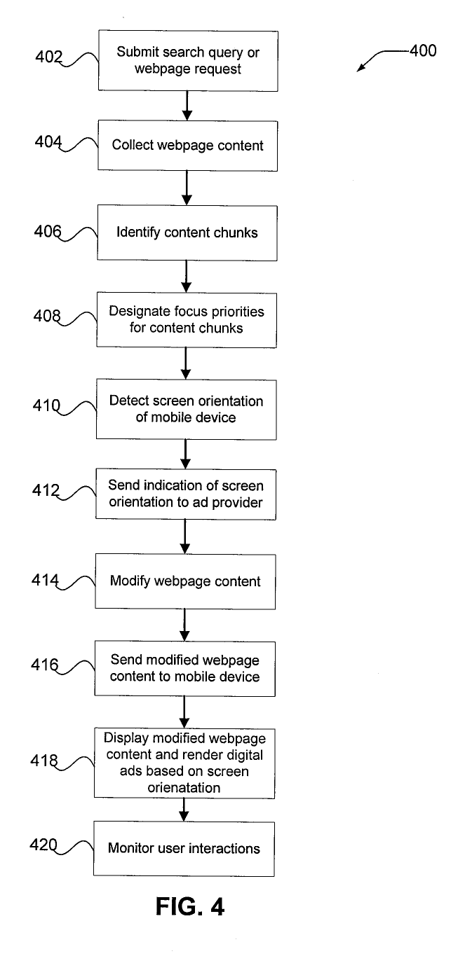

FIG. 4 is a flow chart of a method for optimizing webpage content based on a screen orientation of a mobile device. The method 400 begins at step 402 with an Internet user interacting with a mobile device to request a webpage from a webpage provider or to send a search query to an Internet search engine. At step 404, a webpage template management system collects webpage content from an ad provider, the webpage provider and/or the Internet search engine to send to the mobile device in response to the search query submission or webpage content request of step 402.

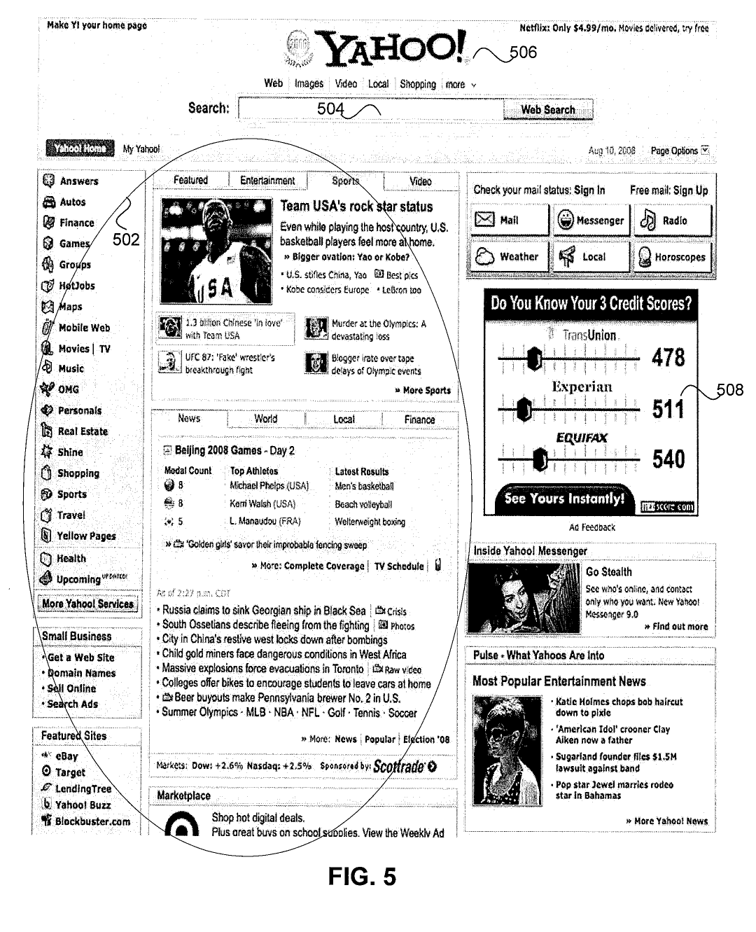

At step 406, the webpage template management system identifies a plurality of content chunks within the collected webpage content. As shown in FIG. 5, a content chunk may be an area of a webpage such as a body of a webpage 502, a search box 504, a title or header 506, or one or more advertisements 508. In some implementations, to assist the webpage template management system in identifying the plurality of content chunks, webpage content is created using a webpage template identifying the plurality of content chunks and a focus priority associated with each content chunk.

Referring again to FIG. 4, at step 408, the webpage template management system associates a focus priority with each of the identified content chunks. Generally, a focus priority indicates a degree to which it is desirable to attract the attention of an Internet user to a content chunk. For example, the webpage template management system may associate a high focus priority with a top-ranked digital ad or a body of a webpage, and associate a low focus priority with a low-ranked digital ad.

At step 410, the mobile device detects an orientation of a screen of the mobile device, and at step 412, the mobile device sends an indication of the detected screen orientation to the webpage template management system. In some implementations the mobile device sends the indication of the screen orientation to the webpage template management system distinct from the Internet user requesting a webpage or submitting a search query at step 402, where in other implementations, the mobile device may send the indication of the screen orientation to the webpage template management system with the request for webpage content or submission of the search query at step 402. At step 414, the webpage template management system modifies the collected webpage content based on the screen orientation of the mobile device, the one or more identified content chunks, and the focus priorities associated with the one or more identified content chunks.

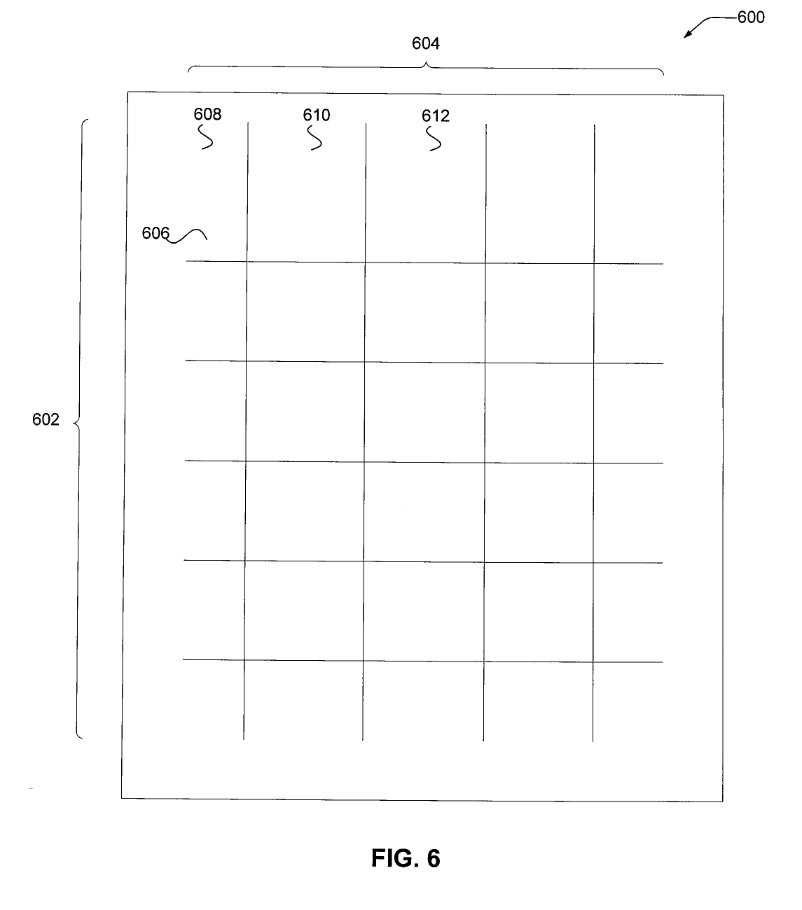

For example, referring to FIG. 6, a webpage 600 may be arranged in a grid containing a plurality of rows 602 and plurality of columns 604. However, in other implementations, a webpage may be arranged in structures other than a grid. When a screen of a mobile device is orientated in a portrait orientation, Internet users may typically interact with digital ads positioned along a top row 606 of the webpage. Therefore, when the screen of a mobile device is orientated in a portrait orientation, the webpage template management system may position digital ads associated with a high focus priority in positions along the top row 606 of the webpage and position other content chunks, such as a body of the webpage, a search bar, or lower-ranked digital ads, at other positions on the webpage.

Similarly, when a screen of a mobile device is orientated in a landscape orientation, Internet users may typically interact with digital ads positioned along a column 608 adjacent to a body of a webpage. Therefore, when a screen of a mobile device is orientated in a landscape orientation, the webpage template management system may position the body of the webpage in a first two columns 610, 612 of the webpage and position digital ads associated with a high focus priority along the column 608 adjacent to the body of the webpage. Further, the webpage template management system may position digital ads or other content chunks associated with a lower focus priority below the body of the webpage.

The webpage template management system may determine which positions of a webpage Internet users typically interact with by monitoring Internet users interactions with webpages, through the use of preset preferences for registered Internet users, or through the use of systems that are able to provide contextually relevant data, such as the systems disclosed in U.S. patent application Ser. No. ______, (Attorney Docket No. 12729/454) titled “System for Providing Contextually Relevant Data,” filed Sep. 29, 2008, and assigned to Yahoo! Inc., the entirety of which is hereby incorporated by reference.

Referring again to FIG. 4, at step 414, in addition to modifying the webpage content to position content chunks at different positions on a webpage, the webpage template management system may additionally modify the webpage content to render different digital ads based on the screen orientation of the mobile device. For example, the webpage template management system may render specific versions of a digital ad based on a screen orientation of a mobile device, such as rendering a textual version of a digital ad when a mobile device is orientated in a portrait orientation and rendering a graphical version of a digital ad when a mobile device is orientated in a landscape orientation. Additionally, the webpage template management system may render digital ads that encourage a user to change the orientation of the mobile device for special offers, or the webpage template management system may render different digital ads all together based on a screen orientation of a mobile device. For example, the webpage template management system may render a first digital ad when a mobile device is orientated in a portrait orientation and render a second digital ad, that is different from the first digital ad, when a mobile device is orientated in a landscape orientation.

At step 416, the webpage template management system sends the modified webpage content to the mobile device. At step 418, the modified webpage content is displayed on the mobile device using applications such as an Internet browser, and at step 420, the webpage template management system, ad provider, website provider, and/or search engine monitors the Internet user's interactions with the displayed content. For example, the webpage template management system may monitor whether the Internet user changes the screen orientation of the mobile device, which portion of the webpage the Internet user interacts with, which digital ads the Internet user clicks on, or any other type of information that may be useful to the webpage template management system.

The webpage template management system, ad provider, website provider, and/or search engine may monitor the Internet user's interactions with the displayed content for use in identifying which areas of the webpage attract the attention of the Internet user for use in modifying webpage content as described above with respect to step 414. The webpage template management system, ad provider, website provider, and/or search engine may additionally monitor the Internet user's interactions with the displayed webpage content for purposes such as billing, reporting, or ad campaign optimization.

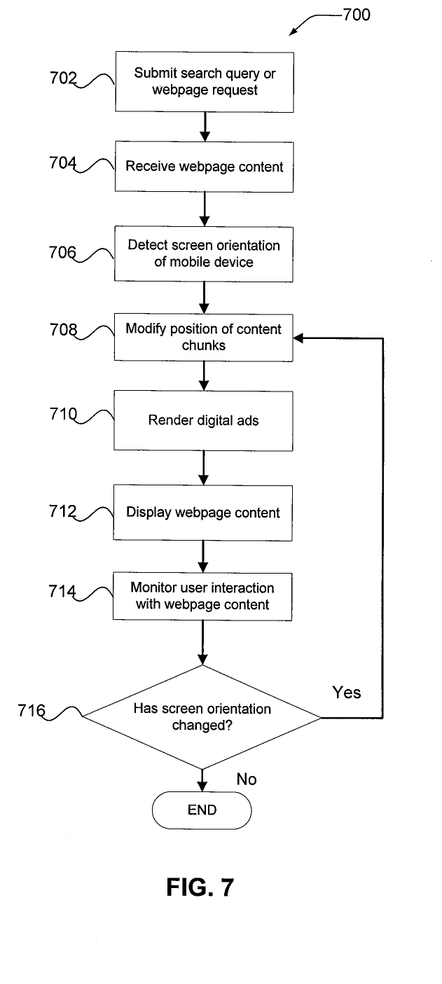

FIG. 7 is a flow chart of another method for optimizing webpage content based on a screen orientation of a mobile device. The method 700 begins at step 702 with an Internet user interacting with a mobile device to request a webpage from a webpage provider or to send a search query to an Internet search engine. At step 704, the mobile device receives webpage content for display on the mobile device from the webpage provider, Internet search engine, ad provider, and/or webpage template management system in response to the search query submission or webpage content request of step 702. The received webpage content may include a webpage template identifying one or more content chunks and a focus priority associated with each content chunk, such as the content chunks and focus priorities described above with respect to FIG. 4.

At step 706, the mobile device detects an orientation of a screen of the mobile device. At step 708, the webpage template modifies the position of the content chunks comprising the webpage based on the screen orientation of the mobile device, the one or more content chunks comprising the webpage, and the focus priorities associated with the one or more identified content chunks. In some implementations, sufficient information is embedded in the webpage template that the webpage template may modify the position of the content chunks of the webpage without the webpage template communicating with an ad provider, website provider, search engine, and/or webpage template management system. However, in other implementations, the webpage template may communicate with an ad provider, website provider, search engine, and/or webpage template management system for assistance in modifying the position of the content chunks of the webpage.

At step 710, for content chunks including digital ads, the webpage template may render different versions of a digital ad, or different digital ads all together, based on the screen orientation of the mobile device. In some implementations, the webpage template may render digital ads based on the screen orientation of the mobile device without communicating with an ad provider and/or webpage template management system. However, in other implementations, the webpage template communicates with an ad provider and/or webpage template management system after the screen orientation of the mobile device is detected to render the digital ads on the webpage. For example, the webpage template may communicate the detected screen orientation of the mobile device to the ad provider and/or the webpage template management system, and the ad provider and/or webpage template management system may send specific versions of a digital ad or specific digital ads for the webpage template to render on the webpage based on the detected screen orientation of the mobile device.

At step 712, the rendered digital ads and other webpage content is displayed on the mobile device using applications such as an Internet browser. At step 714, a webpage template management system, ad provider, website provider, and/or search engine monitor the Internet user's interactions with the displayed content for purposes such as billing, reporting, ad campaign optimization, or identifying which specific portions of displayed webpage content Internet users typically interact with. For example, the webpage template management system, ad provider, website provider, and/or search engine may monitor whether the Internet user changes the screen orientation of the mobile device, which portion of the webpage the Internet user interacts with, which digital ads the Internet user clicks on, or any other type of information that may be useful to the ad provider.

In some implementations, if at step 716 the mobile device detects that the screen orientation of the mobile device changes, the method 700 loops to step 708, where that above-described process is repeated for the webpage template to dynamically modify the webpage content displayed on the mobile device.

FIGS. 1-7 disclose systems and methods for optimizing webpage content based on a screen orientation of a device. By optimizing webpage content, such as digital ads, based on a screen orientation of the mobile device, actions may be performed such as rendering a digital ad at different positions on a webpage based on a screen orientation of the mobile device; rendering different versions of a digital ad based on a screen orientation of the mobile device; and/or rendering different digital ads all together based on a screen orientation of the mobile device.

While the above-described systems and methods have been described with respect to optimizing webpage content including digital ads based on a screen orientation of a device, it will be appreciated that the same systems and methods may be implemented to optimize webpage content that does not include digital ads.

Further, while the above-described systems and methods have been described with respect to optimizing webpage content based on a screen orientation of a mobile device, it will be appreciated that the same systems and methods may be implemented to optimize webpage content based on a screen orientation of other devices such as a desktop display.

Also, while the above-described systems and methods have been described with respect to optimizing webpage content based on a screen orientation of a mobile device, it will be appreciated that the same systems and methods may be implemented to optimize any digital content, such as content other than webpage content, from any source based on a screen orientation of other devices such as a desktop display.

Additionally, while the above-described systems and methods have been described with respect to a content provider or a webpage template management system setting focus priorities associated with content chunks, in other implementations, a user may set the focus priorities associated with content chunks so that the content chunks that are most important to the Internet user, as defined by the Internet user, are presented to the Internet user first. It is therefore intended that the foregoing detailed description be regarded as illustrative rather than limiting, and that it be understood that it is the following claims, including all equivalents, that are intended to define the spirit and scope of this invention.

1. A method for optimizing webpage content based on a screen orientation of a device, the method comprising:
identifying a plurality of content chunks comprising a webpage to display on a device;
receiving an identification of a screen orientation of the device; and
modifying webpage content to display on the device based on the screen orientation of the device, the identified plurality of content chunks, and a focus priority associated with each content chunk of the plurality of content chunks.

2. The method of claim 1, wherein at least one content chunk of the plurality of content chunks comprises a digital ad.

3. The method of claim 1, wherein the device comprises a mobile device.

4. The method of claim 1, wherein the device comprises a desktop display.

5. The method of claim 1, wherein receiving an identification of a screen orientation of a device comprises:
receiving an indication of whether a screen of the device is positioned in one of at least a first orientation or a second orientation.

6. The method of claim 5, wherein one of the first and second orientations is a portrait orientation.

7. The method of claim 5, wherein one of the first and second orientations is a landscape orientation.

8. The method of claim 5, wherein modifying the webpage content comprises:
positioning a digital ad of a first content chunk at a first position on the webpage based on the screen of the device being orientated in the first orientation and a focus priority associated with the first content chunk; and
rendering the digital ad of the first content chunk at a second position on the webpage, that is different from the first position on the webpage, based on the screen of the device being orientated in the second orientation and the focus priority associated with the first content chunk.

9. The method of claim 5, wherein modifying the webpage content comprises:
rendering a first version of a digital ad of a first content chunk on the webpage based on the screen of the device being orientated in the first orientation and a focus priority associated with the first content chunk; and
rendering a second version of the digital ad of the first content chunk, that is different from the first version of the digital ad, on the webpage based on the screen of the device being orientated in the second orientation and the focus priority associated with the first content chunk.

10. The method of claim 9, wherein one of the first and second versions of the digital ad is a textual offer.

11. The method of claim 9, wherein one of the first and second versions of the digital ad is a graphical advertisement.

12. The method of claim 9, wherein one of the first and second versions of the digital ad is a video ad.

13. The method of claim 5, wherein modifying the webpage content comprises:
rendering a first digital ad of a first content chunk on the webpage displayed on the device based on the screen of the device being orientated in the first orientation and a focus priority associated with the first content chunk; and
rendering a second digital ad of the first content chunk, that is different from the first digital ad, on the webpage displayed on the device based on the screen of the device being orientated in the second orientation and the focus priority of the first content chunk.

14. A computer-readable storage medium comprising a set of instructions for optimizing webpage content based on a screen orientation of a device, the set of instructions to direct a processor to perform acts of:
identifying a plurality of content chunks comprising a webpage to display on a device;
receiving an identification of a screen orientation of the device; and
modifying webpage content to display on the device based on the screen orientation of the device, the identified plurality of content chunks, and a focus priority associated with each content chunk of the plurality of content chunks.

15. The computer-readable storage medium of claim 12, wherein receiving an identification of a screen orientation of a device comprises:
receiving an indication of whether a screen of the device is positioned in one of at least a first orientation or a second orientation.

16. The computer-readable storage medium of claim 15, wherein modifying webpage content to display on the device comprises:
rendering a digital ad of a first content chunk at a first position on the webpage based on the screen of the device being orientated in the first orientation and a focus priority of the first content chunk; and
rendering the digital ad of the first content chunk at a second position on the webpage, that is different from the first position on the webpage, based on the screen of the device being orientated in the second orientation and the focus priority of the first content chunk.

17. The computer-readable storage medium of claim 15, wherein modifying webpage content to display on the device comprises:
rendering a first version of a digital ad of a first content chunk on the webpage based on the screen of the device being orientated in the first orientation and a focus priority associated with the first content chunk; and
rendering a second version of the digital ad of the first content chunk, that is different from the first version of the digital ad, on the webpage based on the screen of the device being orientated in the second orientation and the focus priority associated with the first content chunk.

18. The computer-readable storage medium of claim 15, wherein modifying webpage content to display on the device comprises:
rendering a first digital ad of a first content chunk on the webpage displayed on the device based on the screen of the device being orientated in the first orientation and a focus priority of the first content chunk; and
rendering a second digital ad of the first content chunk, that is different from the first digital ad, on the webpage displayed on the device based on the screen of the device being orientated in the second orientation and the focus priority of the first content chunk.

19. A system for optimizing webpage content based on a screen orientation of a device, the system comprising:
a webpage template management system operative to identify a plurality of content chunks comprising a webpage to display on a device; receive an identification of a screen orientation of the device; modify webpage content to display on the device based on the screen orientation of the device, the identified plurality of content chunks, and a focus priority associated with each content chunk of the plurality of content chunks; and forward the modified webpage content to the device.

20. The system of claim 19, wherein at least one content chunk of the plurality of content chunks comprises a digital ad.

21. A method for optimizing digital content based on a screen orientation of a device, the method comprising:
identifying a plurality of content chunks comprising a digital object to display on a device;
receiving an identification of a screen orientation of the device; and
modifying digital content to display on the device based on the screen orientation of the device, the identified plurality of content chunks, and a focus priority associated with each content chunk of the plurality of content chunks.

22. The method of claim 21, wherein the digital object comprises a webpage.

23. The method of claim 22, wherein at least one content chunk of the plurality of content chunks comprises a digital ad.
